(19) United States
(12) Patent Application Publication
(10) Pub. No.: US 2008/0024814 A1
(43) Pub. Date: Jan. 31, 2008

(54) Image forming apparatus, image forming method and storage medium

(75) Inventors: Fumihito Akiyama, Tokyo (JP); Yoko Fujiwara, Tokyo (JP); Jun Kuroki, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/700,872

(22) Filed: Feb. 1, 2007

(30) Foreign Application Priority Data
Jul. 25, 2006 (JP) 2006-202150

(51) Int. Cl. H04N 1/00

(52) U.S. Cl. 358/1.15

(57) ABSTRACT

Disclosed is an image forming apparatus including: a recording section which records job data including image data, and management information indicating a stored state of the job data and possible to be updated; and a control section which refers to the management information recorded in the recording section and executes image formation based on the job data when the stored state of the stored data is indicated to be normal.

### BACKGROUND OF THE INVENTION

1. Field of the Invention

The present invention relates to an image forming apparatus, an image forming method and a storage medium, and more particularly to an image forming apparatus, an image forming method and a storage medium, which can manage stored job files efficiently.

2. Description of Related Art

It is known that image forming apparatuses such as copiers, printers, facsimiles, or multifunction peripherals having functions of these apparatuses, are generally capable of storing/accumulating a plurality of jobs. That is, print data (image data) and the like, inputted from external devices such as PCs (personal computers) are recorded as jobs (such inputted image data and the like will be hereinafter referred to as “job data”) in a large capacity storage medium, such as a hard disk provided in the image forming apparatus. Thereafter, according to an instruction inputted through a control panel or the like, the job data stored (hereinafter referred to as “stored job data”) are read out and printing or the like therefor is performed.

FIG. 7A illustrates a “file production/recording processing” by which a conventional image forming apparatus records job data into a storage medium. In FIG. 7A, a stored job-data management file 100 is a data file recording the address where each file is stored in the storage medium. A print-information setting file 101 is a data file recording various setting information such as setting of color/monochrome printing, recording sheet size, print quality, and the like. Print data files 102a, 102b, . . . , 102n are image data including picture data, text data and the like. When writing job data in the storage medium, the image forming apparatus first produces and writes a stored job-data management file 100, and subsequently produces and writes the print-information setting file 101 and the print data files 102a, 102b, . . . , 102n sequentially. With this sequence, the following problem arises when the print data files 102a, 102b, . . . and 102n are damaged during a writing operation of the image forming apparatus. For instance, in a case that the print data files 102a, 102b, . . . 102n are damaged during writing operation of the print data file in a “file production/recording process” due to some kind of cause (for example, instantaneous voltage drop in a power supply, a device failure, a communication failure or the like) after the image forming apparatus has written the file-management data file. Under this situation, when the image forming apparatus executes a printing process based on the print data files 102a, 102b, . . . , 102n, a problem arises in that the image forming apparatus cannot read the damaged print data file and the like, and results in an operation failure.

In order to solve the problem, there has been developed an image forming apparatus in which all print data files within stored job data are checked before executing the printing process as to whether they are completely written in a storage medium. FIG. 7B schematically illustrates an operation that confirms all print data files within the stored job data by using a check sum method. That is, the image forming apparatus confirms the recording status of files by using check sums provided on the stored job-data management file 100, the print-information setting file 101 and the print data files 102a, 102b, . . . , 102n, then executes the printing process unless each file is found to be abnormal. This process allows the image forming apparatus to solve the operation failure caused by the damage of data.

JP Tokukai-hei-08-297957A (hereinafter, Patent Document 1) discloses an information recording and reproducing device that solves a problem associated with damage of an image data file or the like. The information recording and reproducing device described in Patent Document 1 includes a master disk having information recorded thereon, a plurality of disk drive units for writing data on copying disks, and a control section for controlling these disk drive units. When executing copying process, the control section first executes a process of writing temporary data, instead of disk management data, in a part of a file management area of a copying destination disk. Thereafter, the control section executes a process of copying data, such as images, voice, text and the like, in all areas of the disk except the part of the file management area, and then executes a process of writing true disk management data in the file management area. Usually, when reading a data file recorded in a disk, the control section of the information recording and reproducing device first reads file management data of the file management area, and then accesses the data file based on addresses or the like included in the file management area. That is, the fact that the control section detects the file-management data when reading information recorded in the copying disk means that there is no damage in the copied data. Accordingly; the above-described process allows the information recording and reproducing device to prevent an operation failure caused by data damage.

However, as described above, the image forming apparatus which confirms data damage or the like for all data files before executing a printing process, has a problem of reducing throughput of the apparatus. Since the image forming apparatus confirms check sums for all data files as shown in FIG. 7B every time the apparatus executes a printing process, the process time increases as the number of printing data files increases. Image forming apparatuses in recent years are able to print a highly precise image with large number of pixels as in color printing as well as so-called photographic quality printing. Therefore, data quantity to be dealt increases enormously compared with that for monochrome printing or the like. Accordingly, the process time for confirming check sums for all print data files increases relatively.

The increase of processing time for confirming each file in the stored job data also extremely affects a change occurring while the image forming apparatus executes a printing process. For instance, in a case that, just after the image forming apparatus starts the printing process for specific job data upon receiving a print instruction from a control panel, the apparatus also receives a delete instruction for the specific job data from the control panel, when receiving the print instruction firstly for the specific job data, the image forming apparatus confirms each print data file included in the objective job data by using each check sum. The image forming apparatus receives the delete instruction for the specific job data from the control panel while executing the confirmation. Then, the image forming apparatus executes the delete process for the specific file according to the delete instruction, because the specific job data includes a file-management data file. Since the image forming apparatus does not stop processing until the confirmation process for all print data files of the printing object is completed, the printing process and the delete instruction are executed simultaneously for the specific job data, which causes an operation failure.

The information recording and reproducing device described in Patent Document 1 is superior in that the device executes information-writing operation so as not to cause an operation failure when reading data; however, the device does not solve the problem of instructions overlap, described in the above, occurring when processing the stored job data to which the writing process has been applied.

### SUMMARY

The invention has been developed in order to solve the problem mentioned above, and a first object is to provide an image forming apparatus which can surely record job data into a storage medium so as not to cause an operation failure during execution of printing. Another object is to surely respond to the change occurred while the job data recorded in the storage medium are processed, to thereby prevent the operation failure of the image forming apparatus and to surely execute image formation.

To achieve at least one of the above-mentioned objects, an image forming apparatus reflecting one aspect of the present invention comprises: a recording section which records job data including image data, and management information indicating a stored state of the job data and possible to be updated; and a control section which refers to the management information recorded in the recording section and executes image formation based on the job data when the stored state of the stored data is indicated to be normal.

In the image forming apparatus, preferably, the control section comprises a stored job-data controller which records the job data in the recording section, a stored job-state management section which records the management information in the recording section after the job data have been recorded, and an image forming controller which executes image formation based on the job data when the management information is referred and the stored state of the job data is indicated to be normal.

Preferably, the stored job-state management section records the management information when the stored job-data controller records the job data normally.

Preferably, the stored job-state management section further records, in the management information, identification information indicating that, while the image forming controller executes image formation on job data, other processing is prohibited from accessing the job data.

Preferably, the image forming controller executes image formation based on the job data when the management information is recorded in the recording section and the identification information indicating that other processing is prohibited from accessing the job data, is not recorded in the management information.

Preferably, the image forming apparatus further comprises: a display unit; and a display controller which displays a list of the job data on the display unit.

Preferably, the display controller displays on the display unit a list of job data having the management information recorded therein.

Preferably, the image forming apparatus further comprises an input operation controller which instructs image formation of at least one job data out of the list displayed by the display controller, to the image forming controller based on a user's operation.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a flow chart showing a process sequence of a “file production/recording process” of an image forming apparatus in a preferred embodiment for implementing the invention;

FIG. 2 is a flow chart showing a process sequence of a “printing process” of the image forming apparatus in a preferred embodiment for implementing the invention;

FIG. 3 is a block diagram showing a functional structure of the image forming apparatus in a preferred embodiment for implementing the invention;

FIG. 4 is an explanatory view showing a schematic structure of the image forming apparatus in a preferred embodiment for implementing the invention;

FIG. 5 is an illustration showing one example of an operation screen of the image forming apparatus in a preferred embodiment for implementing the invention;

FIG. 6A is an illustration showing a recording order of data files in the “file production/recording process” of the image forming apparatus in a preferred embodiment for implementing the invention;

FIG. 6B is an illustration showing access operations to data files in the “printing process” of the image forming apparatus in a preferred embodiment for implementing the invention;

FIG. 7A is an illustration showing production and a recording order of each data file in a “file production/recording process” of a conventional image forming apparatus; and

FIG. 7B is an illustration showing access operations to data files in a “printing process” of the conventional image forming apparatus.

### PREFERRED EMBODIMENT OF THE INVENTION

Hereinafter, a description will be given about a multifunction type image forming apparatus 1 to which the present invention is applied, with reference to the drawings. The scope of the invention is not limited to the exemplified drawings.

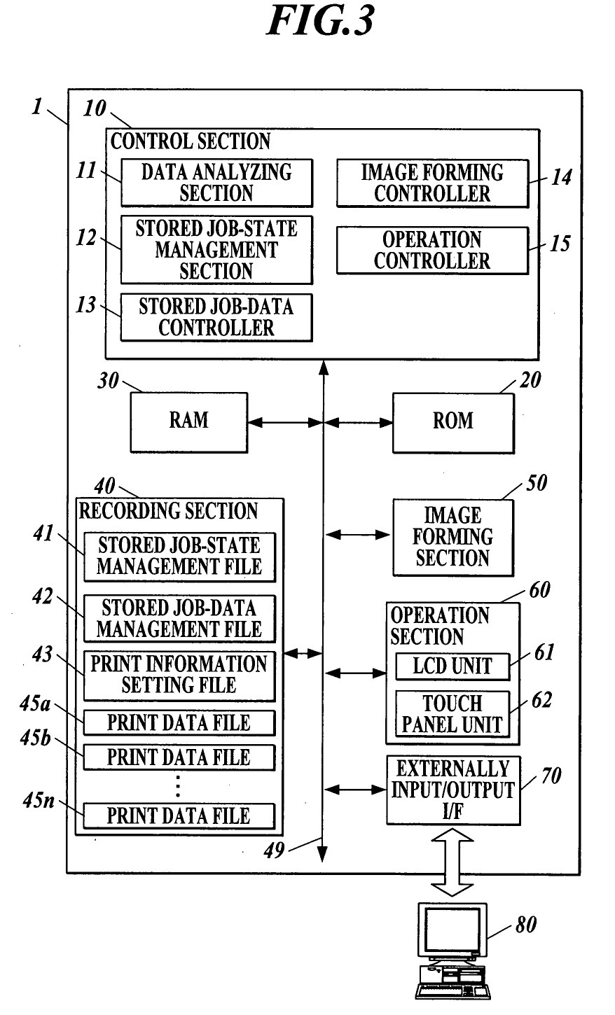

FIG. 3 is a block diagram showing a configuration of the image forming apparatus 1. The image forming apparatus 1 includes a control section 10, a ROM (read only memory) 20, a RAM (random access memory) 30, a recording section 40, an image forming section 50, an operation section 60, and an externally input/output I/F (interface) 70, and these elements are connected to each other electrically/electronically through a bus 49. The image forming apparatus 1 has a printer function in which images are formed on a recording sheet with print data (image data and/or text data) input from a PC 80 as an external terminal. Here, the print data may be input with a digital scanner or the like, alternatively.

The control section 10 has a CPU (central processing unit) or an MPU (micro processing unit), develops operation programs and application programs, which are stored in the ROM 20 or a memory section 5, into the RAM 30 serving as a work area, and executes overall control of the image forming apparatus 1 depending on instructions from the programs. The control section 10 functions as data analyzing section 11, stored job-state management section 12, stored job-data controller 13, image forming controller 14, and operation controller 15.

The data analyzing section 11 performs functions of extracting print data, such as image data or text data, from job data input from the PC 80, and generating print data files 45a, 45b, . . . , 45n.

The stored job-state management section 12 performs functions of generating a stored job-state management file 41, to be described later, and executing writing and updating processes on “job-state information” included in the stored job-state management file 41. The “job-state information” will be described later.

The stored job-data controller 13 performs functions of generating a stored job-data management file 42 and a print information setting file 43, controlling operation of writing/reading various data to/from the recording section 40, and controlling output of the read data to the operation controller 15 and the image forming controller 14.

The image forming controller 14 performs function of controlling a printing process of the image forming section 50 based on the stored job data output from the stored job-data controller 13.

The operation controller 15 performs functions of controlling, as a display controller, various operation screens and operation guidance to be displayed on the operation section 60, and inputting, as an input-operation controller, instruction signals output from the operation section 60 according to user's operation to output the instruction signals to the stored job-data controller 13.

The embodiment is described as an example such that the control section 10 of the image forming apparatus 1 executes processing by one CPU, but it is also possible that each of the control section 10, recording section 40, image forming section 50 and operation section 60 may have a CPU to perform its own function.

The ROM 20 has a nonvolatile semiconductor memory. The ROM 20 stores operation programs of the image forming apparatus 1 and various programs that enable the control section 10 to function as data analyzing section 11, stored job-state management section 12, stored job-data controller 13, image forming controller 14, and operation controller 15. The RAM 30 has a volatile or nonvolatile semiconductor memory. The RAM 30 functions as a work area of the control section 10.

The recording section 40 has, for example, a hard disk or the like, and records operation programs, various application programs and further various data correlated with predetermined addresses. These programs and data are recorded and/or output according to instruction signals from the control section 10. The recording section 40 stores stored job-state management file 41, stored job-data management file 42, print-information setting file 43, and print data files 45a, 45b, . . . , 45n.

The stored job-state management file 41 is a data file indicating whether stored job data which are input from the PC 80 and recorded in the recording section 40, are recorded in a predetermined state. When executing the “file production/recording process” that records the job data input from the PC 80, the stored-job-state management file 41 is recorded after the print data files 45a, 45b, . . . , 45n, the stored job-data management file 42 and the print-information setting file 43 are recorded into the recording section 40. For example, when the print data 45a or the like are not recorded correctly due to instantaneous voltage drop in a power supply, a device failure, a communication failure or the like occurred while the job data input from the PC 80 are in writing operation into the recording section 40, the control section 10 does not generates the stored job-state management file 41.

Further, in a “data writing process”, “job-state information” is recorded in the stored job-state management file 41 as identification information indicating a current processing status of the stored job data. The “job-state information” is used when the stored job data recorded in the recording section 40 is accessed.

For instance, when the input job data have been recorded in the recording section 40, the “job-state information” is recorded as “normal state”. When the stored job data are read out in printing execution, the “job-state information” is updated to “print-executing state”. When the printing is completed, the “job-state information” is updated to the “normal state” again.

On the other hand, in the “printing process” where the image forming apparatus 1 executes printing, the stored job-state management file 41 becomes a file data to which the control section 10 accesses first. When executing the printing process based on the stored job data, the control section 10 determines first whether the stored job-state management file 41 is recorded in the recording section 40, then executes the printing process based on the determination as to whether the “job-state information” of the stored job-state management file 41 is in the “normal state”. That is, in a case that the stored job-state management file 41 is not recorded when executing the printing process, the control section 10 does not access the stored job data. When the “job-state information” indicates other than the “normal state” (“print-executing state”, for example), the control section 10 does not access the stored job data either.

The stored job-data management file 42 is a data file recording addresses where the print data files 45a, 45b, . . . , 45n are stored in the recording section 40. The print-information setting file 43 records various kinds of setting information associated with printing of the print data files 45a, 45b, . . . , 45n. The various kinds of setting information includes, for example, color/monochrome printing, an output size of print data, a size of a recording sheet to be printed thereon, print quality (ranging from highly precise to normal).

The print data files 45a, 45b, . . . , 45n are data files storing image data and/or text data, which are input from the PC 80.

The operation section 60 includes an LCD (liquid crystal display) unit 61 as a display part, and a touch-panel unit 62. The LCD unit 61 is an FPD (flat panel display) having TFT (thin film transistor) elements or the like. The LCD unit 61 displays various operation screens and various operation guides. The touch-panel unit 62 is superposed on the LCD unit 61. The touch-panel unit 62 has a touch panel of an infra-red type or an electrostatic type. Various operation buttons and the like in an operation screen displayed on the LCD unit 61 are correlated with respective coordinate values for vertical direction (Y coordinate) and transverse direction (X coordinate), and when a user pushes a button on the operation screen through the touch-panel unit 62, an instruction signal is output to the control section 10. Here, the instruction signal may be also-input through a hardware key (not shown) provided in the vicinity of the LCD unit 61.

The externally input/output I/F 70 has an interface device such as a NIC (network interface card) or the like. The I/F 70 is connected to the PC 80 through LAN (local area network), MAN (metropolitan area network), WAN (wide area network), or the Internet to permit data communication. The I/F 70 converts job data input from the PC 80 to predetermined formatted data to input to the control section 10.

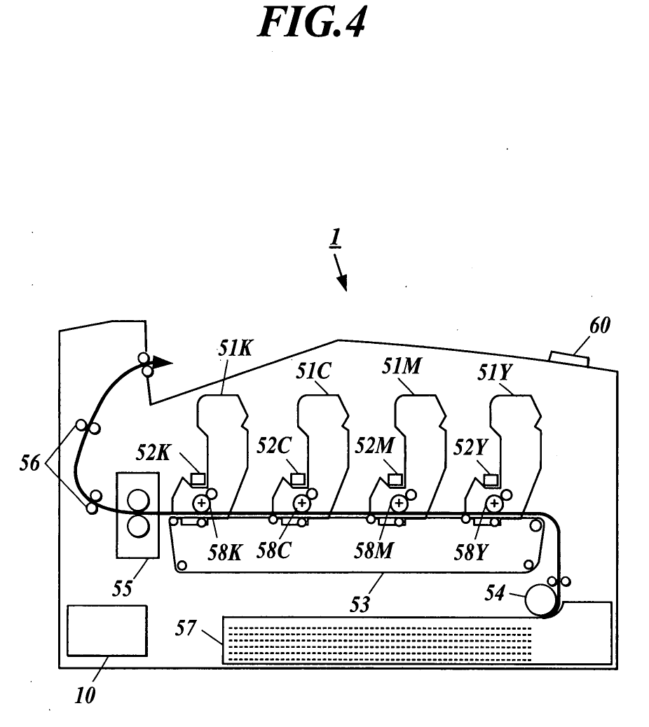

The image forming section 50 includes a known image forming mechanism that forms various images by an electro-photographic process or the like. FIG. 4 shows a schematic structure of the image forming section 50. The image forming section 50 is provided with printer units 51Y, 51M, 51C and 51K for colors Y (yellow), M (magenta), C (cyan) and K (black), respectively. The printer units 51Y, 51M, 51C and 51K include laser units 52Y, 52M, 52C and 52K, respectively. Y-, M-, C- and K-components of rasterized picture data output from the control section 10 are input to the laser units 52Y, 52M, 52C and 52K, respectively. The laser units 52Y, 52M, 52C and 52K irradiate laser light on electrostatic drums 58Y, 58M, 58C and 58K, and form electrostatic latent images thereon, respectively. Color toners (not shown) adhere to respective latent images in the printer units 51Y, 51M, 51C and 51K, so that the latent images are developed to toner images. Thereafter, a paper sheet is fed out from a recording paper cassette 57 which stores recording paper sheets, by feed rollers 54 to a conveying belt 53. The conveying belt 53 conveys the paper sheet to the printer units 51Y, 51M, 51C and 51K in this order, and the previously developed toner images are transferred on the recording medium. After the transfer of the toner images of Y, M, C and K colors has been completed, a fixing device 55 fixes the toner images, and then conveying rollers 56 convey and discharge the medium to a sheet-receiving tray of the image forming apparatus 1.

The image forming section 50 is not limited to this structure, and various kinds of image forming mechanisms such as an inkjet type or a line printer, are applicable.

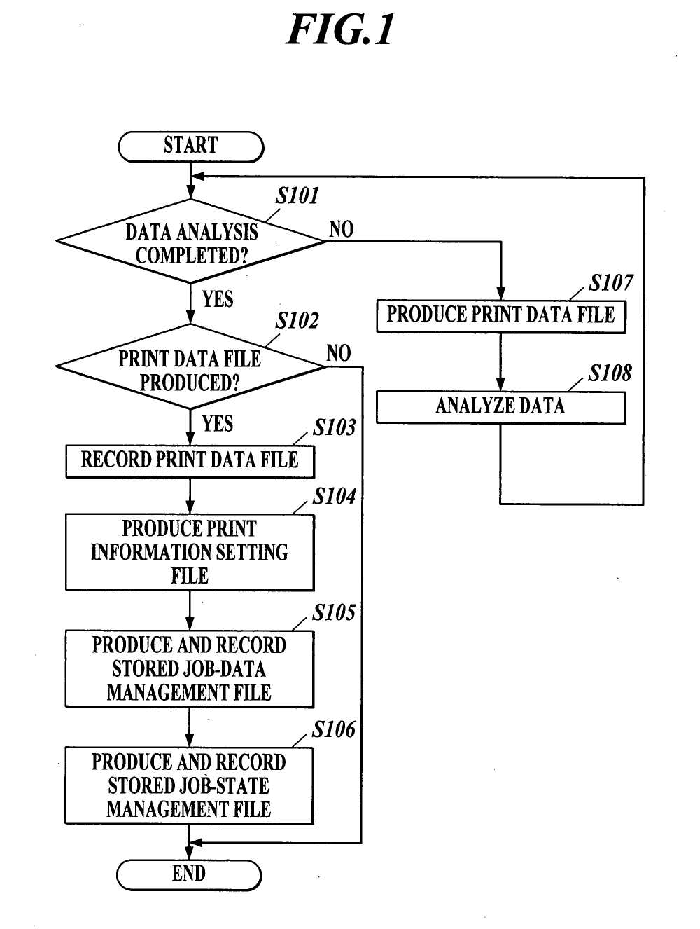

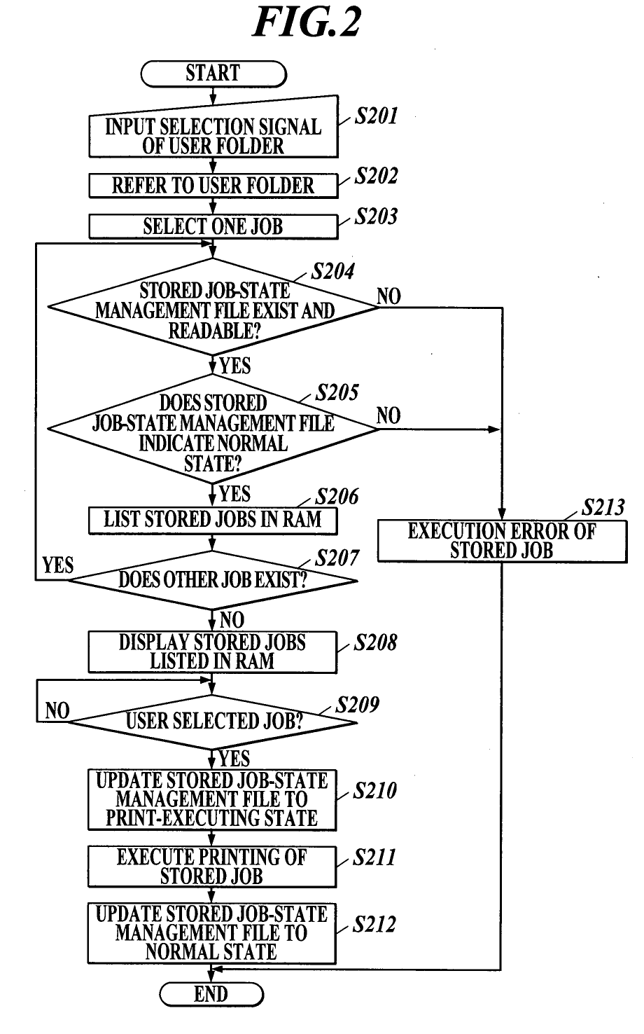

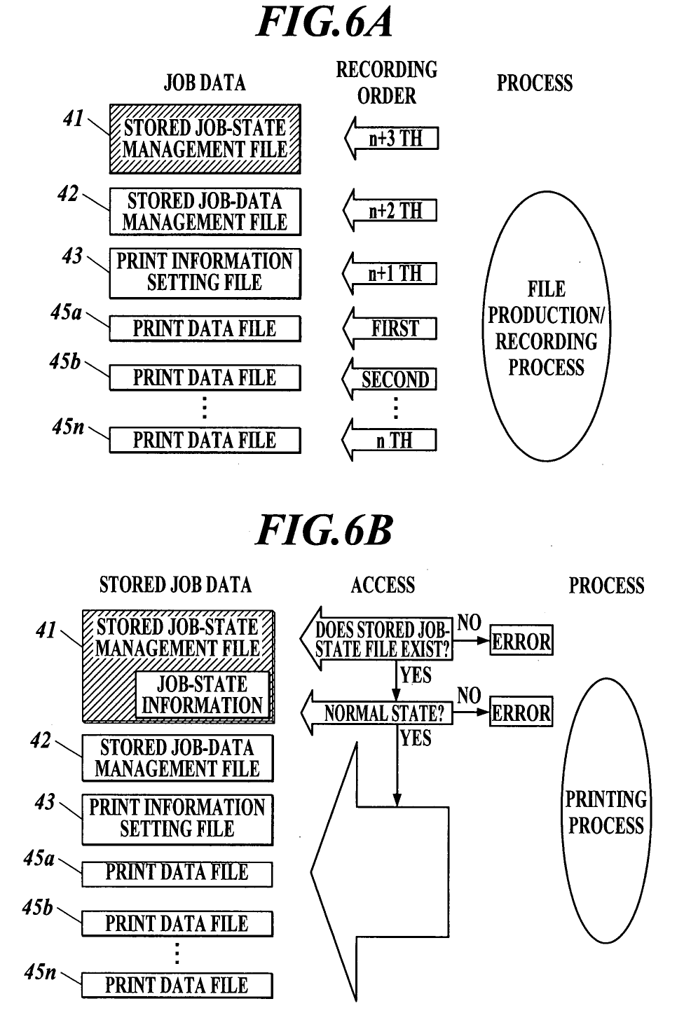

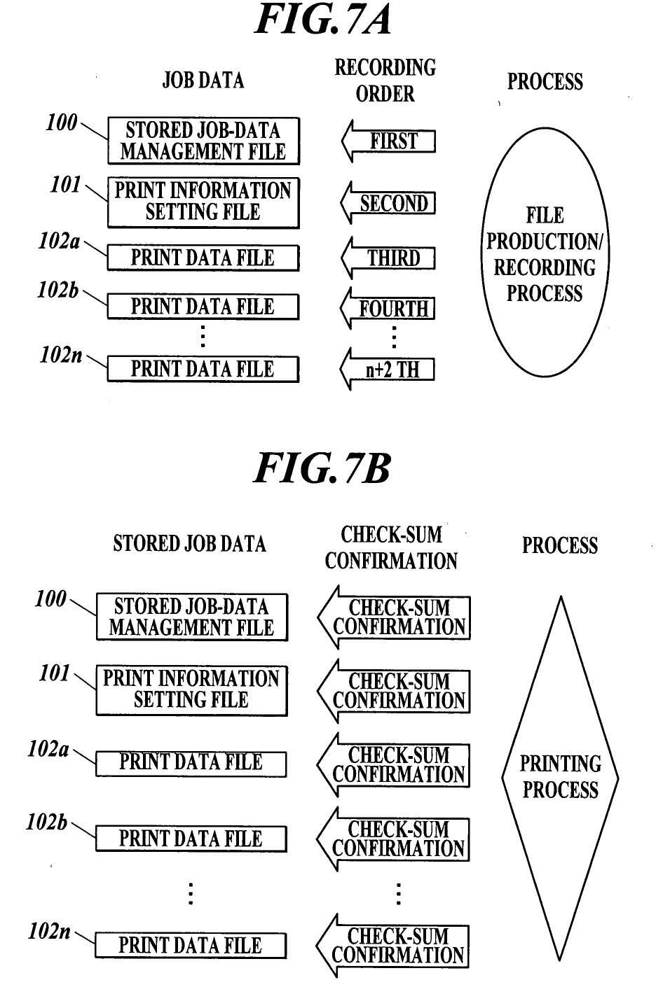

A description will now be given of the operation of each functional section of the control section 10 with reference to flowcharts shown in FIGS. 1 and 2 and illustrations shown in FIGS. 6A and 6B. For explaining each functional section, the “file production/recording process” which records job data input from the PC 80 into the recording section 40, and the “printing process” which executes printing based on the stored job data recorded with the recording process, will be explained. FIG. 6A is an illustration showing a recording order of data files produced from job data in the “file production/recording process”, and FIG. 6B is an illustration showing an access operation to the stored job data in the “printing process”.

Here, the process explained below is executed according to instructions from a program.

### [File Production/Recording Process]

FIG. 1 shows a process sequence of the “file production/recording process” executed by the control section 10.

At step S101, when job data have been input from the PC 80 through the input/output I/F 70, the data analyzing section 11 determines whether analysis of the job data has been completed. When the data analyzing section 11 determines that the analysis of the job data has been completed, the process proceeds to step S102 (YES at step S101). When the data analyzing section 11 determines that the analysis of the job data has not been completed, the process proceeds to step S107 (NO at step S101). The process after step S107 will be described later.

At step S102, the stored job-data controller 13 determines whether the data analyzing section 11 has produced the print data files 45a, 45b, . . . , 45n with the processing at step S101. When the stored job-data controller 13 determines that the print data files 45a, 45b, . . . , 45n have been produced, the process proceeds to step S103 (YES at step S102). When the stored job-data controller 13 determines that the print data files 45a, 45b, . . . , 45n have not been produced, the process ends (NO at step S102).

At step S103, the stored job-data controller 13 records the print data files 45a, 45b, . . . , 45n in the recording section 40. That is, the print data files 45a, 45b, . . . , 45n are recorded prior to recording of the stored job-data management file 42 and the print information setting file 43 (FIRST, SECOND, . . . , n TH in FIG. 6A).

At step S104, the stored job-data controller 13 extracts from the input job data, the information associated with setting for printing, the information including color/monochrome printing, an output size of print data, a size of a recording sheet to be printed thereon, print quality (ranging from highly precise to normal), etc., and produces the print information setting file 43, then records the print information setting file 43 into the recording section 40 (n+1 TH in FIG. 6A).

At step S105, the stored job-data controller 13 produces the stored job-data management file 42 that records addresses indicating stored positions of the print data files 45a, 45b, . . . 45n and the print information setting file 43, then records the stored job-data management file 42 into the recording section 40 (n+2 TH in FIG. 6A).

At step S106, the stored job-state management section 12 detects the state that the stored job-data controller 13 has recorded the print data files 45a, 45b, . . . , 45n, the print information setting file 43 and the stored job-data management file 42 in the recording section 40 at steps S103 through S105, then produces and records the stored job-state management file 41 (n+3 TH in FIG. 6A).

At the same time, the information “normal state” is recorded in the stored job-state management file 41 produced and recorded by the stored job-state management section 12, the “normal state” indicating that the stored job-data controller 13 has normally recorded the print data files 45a, 45b, . . . , 45n, the print information setting file 43 and the stored job-data management file 42.

Next, processing after step S107 will be described. At step S107, the data analyzing section 11 analyzes the input job data, extracts print data and produces the print data files 45a, 45b, . . . 45n.

Thereafter, at step S108, the data analyzing section 11 analyzes various kinds of information included in a header part of the job data, the information including data name, capacity, data format, setting for printing, and the like. After the data analyzing section 11 finishes analyzing the information, the process returns to step S101.

The “file production/recording process” is executed as described above. Thus, by producing/recording the print data files 45a, 45b, . . . , 45n first and producing/recording the stored job-state management file 41 at the end, reliability of the recorded state of job data is improved.

### [Printing Processing]

Next, the “printing process” will be explained. When functional sections of the control section 10 accesses a predetermined stored job data in the “printing process”, the control section 10 determines first whether the stored job-state management file 41 is recorded or not, and determines, in a case of recorded, whether the job-state information in the stored job-state management file 41 is the “normal state” or not. FIG. 2 shows a process sequence in the “printing process”.

Here, the following process is executed by the functional sections of the control section 10 according to instructions from a program.

First, at step S201, according to a signal input from the operation section 60 by a user's operation requesting display of a job list, the operation controller 15 requests the stored job-data controller 13 to read the stored job data (step S202).

Next, at step S203, responding to the display request from the operation controller 15, the stored job-data controller 13 selects one stored job out of the stored job data stored in a predetermined user folder, and starts accessing the job data.

At step S204, the stored job-data controller 13 determines first whether the stored job-state management file 41 exists and whether the job-state information is the “normal state” for the stored job data to which step S203 started accessing (see FIG. 6B). When the stored job-state management file 41 exists and can be read normally, the stored job-data controller 13 proceeds to processing in step S205 (YES at step S204). When the stored job-state management file 41 is not recorded or cannot be read normally, the stored job-data controller 13 proceeds to processing in step S213 (NO at step S204) to express an execution error of the stored job, and the process ends.

At step S205, the stored job-data controller 13 determines whether the job-state information is the “normal state” (see FIG. 6B). When it is determined that the job-state information is the “normal state”, the stored job-data controller 13 proceeds to processing in step S206. When determined not the “normal state” (for example, “print-executing state”), the stored job-data controller 13 proceeds to processing in step S213 (NO at step S205) to express an execution error of the stored job, and the process on this flow ends.

At step S206, the stored job-data controller 13 extracts the stored job data in which the job-state information is the “normal state” at step S205, into the RAM 30.

At step S207, the stored job-data controller 13 determines whether other stored job data exist in the user folder. The stored job-data controller 13 proceeds to processing in step S208 when other stored job data does not exist (NO at step 207), and returns to processing in step S204 when other stored job data exist (YES at step 207).

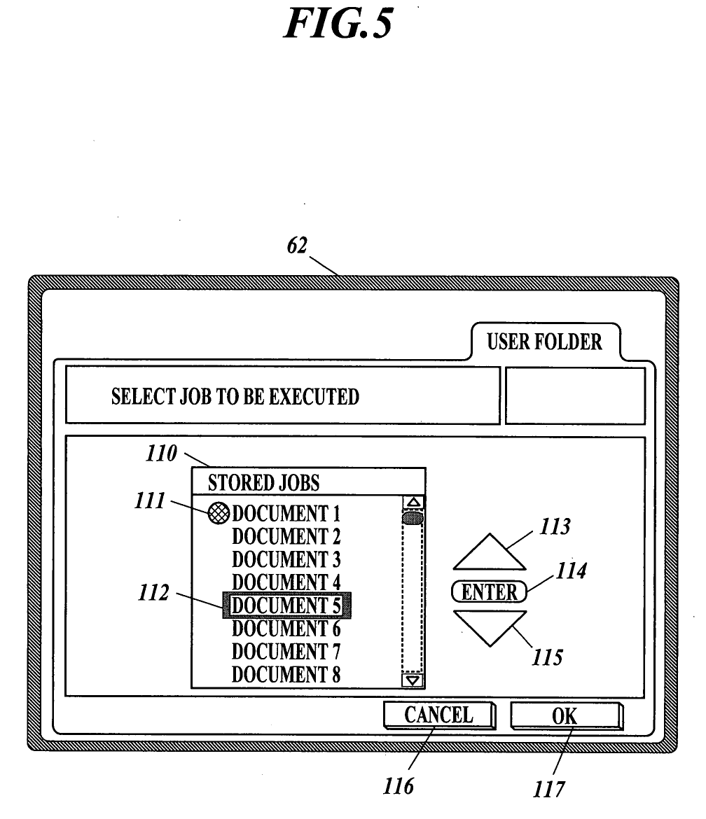

At step S208, the stored job-data controller 13 sends an instruction signal to the operation controller 15 to display the list of the stored job data, which are recorded in the RAM 30 at step S206, on the operation section 60. FIG. 5 shows a screen example on the operation section 60 (LCD unit 61) on which the list of the stored job data is displayed. The stored job data are displayed in a stored job-list display area 110, being presented as, for example, “DOCUMENT 1”, “DOCUMENT 2”, . . . When a user selects a stored job data to be printed, the user presses an UP button 113 or a DOWN button 115 to position a cursor 112 on a desired “DOCUMENT”, and depresses an ENTER button 114. At the left side of the selected and decided “DOCUMENT”, a check mark 111 which indicates finishing of selection, is displayed. After finishing selection of the “DOCUMENT”, by pressing an OK button 117, a selection signal is input to the operation controller 15.

At step S209, the stored job-data controller 13 waits for the selection signal to be input from the operation controller 15. That is, the selection signal of the stored job data is waited to be input, the job data being selected by the user for execution of printing from the list displayed on the operation section 60 (LCD unit 61) at step S208. When the selection signal is input from the operation controller 15, the stored job-data controller 13 proceeds to processing in step S210 (YES at step S209).

At step S210, the stored job-state management section 12 updates the stored job-state management file 41 to the “print-executing state”.

At step S211, the stored job-data controller 13 reads out the print information setting file 43 and the print data files 45a, 45b, . . . , 45n based on addresses recorded in the stored job-data management file 42, and outputs them to the image forming controller 14. The image forming controller 14 generates video signals rasterized from the print data files 45a, 45b, . . . , 45n, and outputs them to the image forming section 50. The image forming section 50 forms images on a recording sheet based on the print data files 45a, 45b, . . . , 45n and the print information setting file 43, thus executes printing.

At step S212, the stored job-state management section 12 updates the job-state information of the stored job-state management file 41 back to the “normal state” from the “print-executing state”, and the process on this flow ends.

According to the image forming apparatus 1 to which the invention is applied, in the “file production/recording process” where job data input from the PC 80 are recorded in the recording section 40, the stored job-state management file 41 indicating the stored state of the job data is recorded together with the job data. In the “printing process”, it is determined first whether the stored job-state management file 41 is recorded for the stored job data as an object to be printed, and then printing is executed. Therefore, image formation can be executed based on the job data that are normally recorded at a recording stage of the job data. That is, the stored state of the job data at the recording stage can be reflected to the printing process, so that an operation failure of the image forming apparatus caused by damage of the stored job data can be prevented. Since the stored job-state management file 41 is recorded after the job data has been recorded, reliability for the recorded state of the job data can be improved. Further, the stored job-state management file 41 has the information of “normal state” recorded therein, the normal state indicating that job data has been recorded normally. This allows the job data having the “normal state” information to be discriminated as job data recorded normally.

According to the image forming apparatus 1, the stored job-state management file 41 further has job-state information recorded therein, the information indicating that other processing is prohibited from accessing the stored job data that are in image forming execution process. This allows the printing process-executed stored job data to be discriminated from other stored job data on which printing process is not executed, so that one stored job data can be prevented from simultaneous execution by two or more different processes.

Furthermore, when the list of stored job data is displayed on the operation section 60 (LCD unit 61), only the stored job data, having the stored job-state management file 41 recorded therein, are displayed on the list, and therefore the user is prevented from erroneously instructing printing of stored job data that are possible to have damage in the data files or the like.

The image forming apparatus 1 according to the invention has been described above, and the invention is not limited to the above various examples.

The present U.S. patent application claims a priority under the Paris Convention of Japanese patent application No. 2006-202150 filed on Jul. 25, 2006, and shall be a basis of correction of an incorrect translation.

What is claimed is:

1. An image forming apparatus comprising:
a recording section which records job data including image data, and management information indicating a stored state of the job data and possible to be updated; and
a control section which refers to the management information recorded in the recording section and executes image formation based on the job data when the stored state of the stored data is indicated to be normal.

2. The image forming apparatus of claim 1, wherein the control section comprises a stored job-data controller which records the job data in the recording section, a stored job-state management section which records the management information in the recording section after the job data have been recorded, and an image forming controller which executes image formation based on the job data when the management information is referred and the stored state of the job data is indicated to be normal.

3. The image forming apparatus of claim 2, wherein the stored job-state management section records the management information when the stored job-data controller records the job data normally.

4. The image forming apparatus of claim 2, wherein the stored job-state management section further records, in the management information, identification information indicating that, while the image forming controller executes image formation on job data, other processing is prohibited from accessing the job data.

5. The image forming apparatus of claim 4, wherein the image forming controller executes image formation based on the job data when the management information is recorded in the recording section and the identification information indicating that other processing is prohibited from accessing the job data, is not recorded in the management information.

6. The image forming apparatus of claim 2, further comprising:
a display unit; and
a display controller which displays a list of the job data on the display unit.

7. The image forming apparatus of claim 6, wherein the display controller displays on the display unit a list of job data having the management information recorded therein.

8. The image forming apparatus of claim 6, further comprising an input operation controller which instructs image formation of at least one job data out of the list displayed by the display controller, to the image forming controller based on a user's operation.

9. An image forming method comprising:
a recording step which records job data including image data, and management information indicating a stored state of the job data and possible to be updated; and
a control step which refers to the management information recorded in a recording section and executes image formation based on the job data when the stored state of the job data is indicated to be normal.

10. The image forming method of claim 9, wherein the control step comprises a stored job-data control step which records the job data, a stored job-state management step which records the management information after the job data have been recorded, and an image forming control step which refers to the management information and executes image formation based on the job data when the stored state of the stored data is indicated to be normal.

11. The image forming method of claim 10, wherein the stored job-state management step records the management information when the job data are recorded normally in the stored job-data control step.

12. The image forming method of claim 10, wherein the stored job-state management step further records identification information indicating that, while image formation is executed on job data in the image forming control step, other processing is prohibited from accessing the job data, in the management information.

13. The image forming method of claim 12, wherein the image forming control step executes image formation based on the job data when the management information is recorded in the recording section and the identification information, indicating that other processing is prohibited from accessing the job data, is not recorded in the management information.

14. The image forming method of claim 10, further comprising a display control step which displays a list of the job data.

15. The image forming method of claim 14, wherein the display control step displays a list of job data having the management information recorded therein.

16. The image forming method of claim 14, further comprising an input operation control step which instructs image formation of at least one job data out of the list displayed at the display control step, based on user's operation.

17. A computer-readable storage medium storing a program causing a computer for controlling an image forming apparatus to realize:
a recording function to record job data including image data, and management information indicating a stored state of the job data and possible to be updated; and
a control function to refer to the management information recorded by the recording function and to execute image formation based on the job data when the stored state of the job data is indicated to be normal.

18. The storage medium of claim 17, wherein the control function comprises a stored job-data control function which records the job data, a stored job-state management function which records the management information after the job data have been recorded, and an image forming control function which refers to the management information and executes image formation based on the job data when the stored state of the stored data is indicated to be normal.

19. The storage medium of claim 18, wherein the stored job-state management function further records the management information when the job data has been recorded normally by the stored job-data control function.

20. The storage medium of claim 18, wherein the stored job-state management function further records in the management information, identification information indicating that, while image formation is executed on job data by the image forming control function, other processing is prohibited from accessing the job data.

21. The storage medium of claim 20, wherein the image forming control function executes image formation based on the job data when the management information is recorded in a recording section and the identification information indicating that other processing is prohibited from accessing the job data, is not recorded in the management information.

22. The storage medium of claim 18, further comprising a display control function to display a list of the job data.

23. The storage medium of claim 22, wherein the display control function displays a list of job data having the management information recorded therein.

24. The storage medium of claim 22, further comprising an input operation control function which instructs image formation of at least one job data out of the list displayed by the display control function, based on user's operation.
